(19) United States
(12) Patent Application Publication
(10) Pub. No.: US 2014/0337751 A1
(43) Pub. Date: Nov. 13, 2014

(54) AUTOMATIC CREATION OF CALENDAR ITEMS

(71) Applicant: Microsoft Corporation, Redmond, WA (US)

(72) Inventors: Melissa Lim, Seattle, WA (US); Jared Brown, Kirkland, WA (US); Joseph A. Schrader, Kirkland, WA (US); Terri Chudzik, Seattle, WA (US); Jared Frew, Seattle, WA (US); Shawn Cantin Callegari, Redmond, WA (US); Tyler N. Jensen, Seattle, WA (US); Ashish Gupta, Bothell, WA (US); Renle Xia, Redmond, WA (US); Joseph B. Tobens, Seattle, WA (US); Gurpreet Virdi, Redmond, WA (US); Michael McGee, Bellevue, WA (US)

(73) Assignee: Microsoft Corporation, Redmond, WA (US)

(21) Appl. No.: 13/892,990

(22) Filed: May 13, 2013

(51) Int. Cl. G06F 3/0484

(52) U.S. Cl. CPC G06F 3/0484
USPC 715/744

(57) ABSTRACT

Techniques are described for automatically creating calendar items. For example, calendar-related activity can be detected within user-accessed content on a computing device. In response to the detected calendar-related activity, calendar information can be displayed to a user of the computing device that indicates availability of the user. The user can indicate initiate creation of a calendar item based on the detected calendar-related activity and save the calendar item to the user's calendar.

### BACKGROUND

Users are increasingly relying on their mobile devices to communicate with others and plan their activities. For example, users can communicate and plan activities when using various types of communication on their mobile phones, such as during a phone call, through text messages, or when using social networking applications.

Some attempts have been made to assist users with scheduling calendar events based on such user communications. For example, attempts have been made to recognize specific terms in a text communication, such as “lunch” and “dinner”, dates, and times. Based on these recognized terms, existing solutions can propose an event to be scheduled in the user's calendar.

However, such existing solutions have a number of limitations. For example, existing solutions may not be able to detect that a user wants to schedule an event from content that is not text-based (e.g., something other than emails and text messages). In addition, existing solutions may require the user to access a separate application, such as a calendar application, in order to schedule the event or view the user's schedule. For example, with an existing solution, a user may have to leave the current application and launch a calendar application in order for the user to determine whether he or she is busy at a particular time, or to see what other events the user has currently scheduled for a particular day.

Therefore, there exists ample opportunity for improvement in technologies related to automatically scheduling calendar items.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and tools are described for automatically creating calendar items. For example, calendar-related activity can be detected within user-accessed content on a computing device, such as a mobile phone. In response to the detected calendar-related activity, calendar information can be presented (e.g., in an audio and/or visual format) to a user of the computing device that indicates availability of the user. The user can initiate creation of a calendar item based on the detected calendar-related activity, add or edit details for the calendar item, and save the calendar item (e.g., to the user's calendar). Calendar-related activity can be detected within different types of user-accessed content comprising text user-accessed content, digital ink user-accessed content, picture user-accessed content, third-party application user-accessed content, and web page user-accessed content.

For example, a method can be provided for automatically creating calendar items. The method can be performed, at least in part, by a mobile computing device such as a mobile phone. The method comprises detecting calendar-related activity within user-accessed content, in response to detecting the calendar-related activity, presenting, to a user, calendar information that is relevant to the calendar-related activity, receiving an indication that the user wants to create a calendar item based, at least in part, on the detected calendar-related activity, and saving the calendar item in the user's calendar. The method can be configured to detect calendar-related activity within user-accessed content comprising text user-accessed content, picture user-accessed content, third-party application user-accessed content, and web page user-accessed content.

As another example, a method can be provided for automatically creating calendar items. The method can be performed, at least in part, by a mobile computing device such as a mobile phone. The method comprises detecting calendar-related activity within user-accessed content, in response to detecting the calendar-related activity, displaying, to a user, calendar information that is relevant to the calendar-related activity, receiving an indication that the user wants to create a calendar item based, at least in part, on the detected calendar-related activity, in response to receiving the indication that the user wants to create a calendar item, displaying, to the user, calendar details for creating the calendar item, where at least some of the calendar details are populated automatically from the calendar-related activity detected with the user-accessed content, and saving the calendar item in the user's calendar. The method can be configured to detect calendar-related activity within user-accessed content comprising text user-accessed content, digital ink user-accessed content, picture user-accessed content, third-party application user-accessed content, and web page user-accessed content.

As another example, computing devices comprising processing units, memory, and displays can be provided for performing operations described herein. For example, a mobile computing device, such as a mobile phone, can perform operations for automatically creating calendar items from user-accessed content.

As described herein, a variety of other features and advantages can be incorporated into the technologies as desired.

### BRIEF DESCRIPTION OF THE DRAWINGS

FIG. 1 is a flowchart of an example method for automatically creating calendar items.

FIG. 2 is a flowchart of an another example method for automatically creating calendar items.

FIG. 3 depicts example screenshots for automatically creating calendar items within an SMS application in an example implementation.

FIG. 4 depicts an example screenshot for automatically creating calendar items, including displaying graphical free-busy information.

FIG. 5 is a diagram of an example environment supporting automatic creation of calendar items by mobile computing devices.

FIG. 6 is a diagram of an exemplary computing system in which some described embodiments can be implemented.

FIG. 7 is an exemplary mobile device that can be used in conjunction with the technologies described herein.

FIG. 8 is an exemplary cloud-support environment that can be used in conjunction with the technologies described herein.

### DETAILED DESCRIPTION

### Example 1

### Overview

As described herein, various techniques and solutions can be applied for automatically creating calendar items. For example, calendar-related activity (e.g., information indicating activity that the user may want to schedule, such as descriptions, dates, times, participants, etc.) can be detected within user-accessed content on a computing device, such as a mobile phone. In response to the detected calendar-related activity, calendar information can be presented (e.g., in an audio and/or visual format) to a user of the computing device that indicates availability of the user (e.g., free-busy information). The user can initiate creation of a calendar item based on the detected calendar-related activity, add or edit details for the calendar item, and save the calendar item (e.g., to the user's calendar).

Calendar-related activity can be detected within various types of user-accessed content. For example, calendar-related activity can be detected within text content (e.g., text messages, instant messages, emails, etc.), audio content (e.g., voice calls, voice messages, etc.), visual content (e.g., digital pictures, captured images, etc.), digital ink content (e.g., after being converted to text using handwriting recognition), web page content, third-party applications, and other types of user-accessed content. For example, a user may be communicating with a friend via text messages or email. The user may also be browsing a web page to view information for a music concert. As another example, the user may take a picture of an event poster.

When the calendar-related activity is detected, calendar information can be presented to the user. For example, the calendar information can indicate availability of the user (availability information) (e.g., free-busy information from the user's calendar, specific calendar items scheduled in the user's calendar, proposed times that the user is free for scheduling, etc.). Using the presented calendar information, the user can quickly and easily decide whether to create a calendar item.

Creation of calendar items can be performed automatically without the user having to leave the application the user is currently using. For example, a user can be communicating with a friend using a text message application. While using the text message application, calendar-related activity can be detected within the text message content, calendar information can be displayed (e.g., a pop-up user interface area displaying free-busy information for a business meeting on a particular day that is being proposed in the text message content), the user can indicate that the user wants to create a calendar item for the meeting (e.g., by selecting a link or icon displayed in the user interface area), the user can enter or modify calendar details (e.g., meeting description, participants to invite, etc.), and the user can save the calendar item to the user's calendar. All this can be performed by the user without having to launch a separate application or applications (e.g., without having to launch a calendar application).

### Example 2

### Calendar Items

Calendar items refer to items that can be created and stored (e.g., scheduled) in a user's calendar. For example, a user can create calendar items via the user's computing device (e.g., mobile phone, tablet device, laptop computer, desktop computer, or other type of computing device) and store them in the user's calendar (e.g., in a calendar application on the user's device, in an on-line calendar accessed via a web site, in a cloud-based calendar, or in another type of electronic calendar).

Calendar items can represent different types of activity. One type of calendar item is an appointment. An appointment can be an activity that does not involve inviting other people. For example, a user can create a calendar item for a haircut appointment or for a doctor appointment.

Another type of calendar item is a meeting. A meeting can be an activity that involves other people. For example, a user can create a calendar item for a business meeting to discuss a work project. The user can invite the other people to the meeting.

Another type of calendar item is an event. An event can be an activity for a particular occasion. Examples of events include trade shows, sporting events, concerts, birthdays, vacations, etc.

### Example 3

### Calendar-Related Activity

Calendar-related activity is to any type of information that refers to (e.g., is related to, suggests, or indicates) a calendar item. For example, calendar-related activity can comprise information suggesting a calendar item (e.g., terms such as “lunch,” “dinner,” “movie,” or “meeting”), information describing a type of the calendar item (e.g., appointment, meeting, event), information describing a date and/or time for the calendar item, information describing a location for the calendar item (e.g., a particular restaurant, venue, or conference room), information describing other people (e.g., a friend for a lunch appointment, people to invite for a meeting, etc.), or other information describing the calendar item.

Calendar-related activity can be detected in a variety content accessed by a user (user-accessed content). For example, calendar-related activity can be detected in text communications (e.g., short message service (SMS) communications, instant message (1M) communications, text chat communications, email communications, communications in social networking applications, and other types of text communications). Calendar-related activity can also be detected in other types of communications, such as audio communications (e.g., a voice call or voice messages) and video communications (e.g., a video call).

Calendar-related activity can be detected in other types of user-accessed content. For example, calendar-related activity can be detected in picture content (e.g., a picture of a concert poster listing a date and time), third-party application content (e.g., a restaurant booking application), web page content (e.g., a web page displaying information for a particular sporting event), and other types of user-accessed content. For example, a user may take a picture of a concert poster using the user's mobile phone. The mobile device can detect calendar-related activity from the concert poster picture (e.g., information indicating that the user may want to create a calendar item for the concert, such as the concert name, location, date, and time).

Calendar-related activity can be determined or inferred from a context. For example, if a user is communicating with a friend via SMS to setup a lunch meeting, the calendar-related activity can include an indication that a lunch is being planned between the user and the friend (e.g., the friend can be determined to be relevant to the lunch meeting due to the SMS communication context between the user and the friend even if the communication does not explicitly state that the lunch will be with the friend).

### Example 4

### Calendar Information

Calendar information refers to any information that indicates availability of a user and/or availability relevant to calendar-related activity. Availability of a user can be based on one or more calendars associated with the user and/or based on other scheduling information associated with the user. Availability relevant to calendar-related activity can be based on calendars or scheduling information of one or more other users (e.g., other users participating in the calendar-related activity, such as a meeting or appointment) or calendars or scheduling information of one or more other entities (e.g., a calendar of a business or venue).

Calendar information can comprise free-busy information. For example, free-busy information can indicate time periods (e.g., dates and/or times) when the user is free or otherwise available (e.g., when the user does not have any calendar items scheduled) and/or time periods when the user is busy or otherwise unavailable (e.g., when the user has one or more calendar items scheduled). Free-busy information can also indicate time periods when the user is tentatively busy or otherwise tentatively unavailable (e.g., when the user has received a request to schedule a calendar item but has not yet accepted the request).

Calendar information that is relevant to calendar-related activity can be determined. For example, the calendar information can be relevant to the date and/or time of the calendar-related activity. For example, consider a user that is messaging a friend over SMS and suggests they get together for lunch on Monday. In response to detecting the calendar-related activity (lunch on Monday) in the SMS communication, the user's calendar can be accessed to determine relevant calendar information (e.g., calendar information on or around lunch time on Monday and/or any other calendar information that may be relevant to lunch on Monday). For example, the user's calendar may contain a work meeting at 9:00 am on Monday. Such calendar information can be displayed (e.g., that the user is busy with a work meeting at 9:00 am to 11:00 am on Monday) which can assist the user in deciding whether or not to schedule the lunch. Additional or other calendar information can also be displayed, such as calendar information from the friend's calendar and/or calendar information for the lunch location (e.g., reservation availability for a restaurant).

Calendar information can also include predicted information. For example, the user may be discussing lunch with a friend during the week. Even though a specific day or time may not be discussed, the user's calendar can be used (e.g., separately or in combination with other calendars, such as the friend's calendar) to suggest days and times that are free. For example, the calendar information can comprise days and times that the user and the friend are both available (e.g., they may both be available on Wednesday and Friday for lunch at 12:00-1:00 pm). In some implementations, options for available days and/or times can be presented to the user for selection.

### Example 5

### Methods for Automatically Creating Calendar Items

In any of the examples herein, methods can be provided for automatically creating calendar items. For example, such methods can be performed, at least in part, by a computing device (e.g., a mobile computing device, such as a mobile phone).

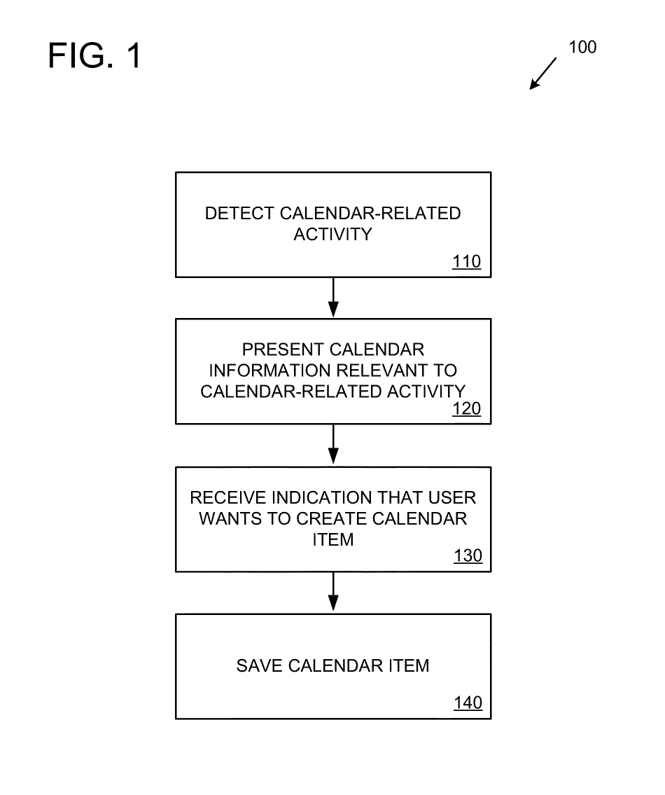

FIG. 1 is a flowchart of an example method 100 for automatically creating calendar items. The example method 100 can be performed, at least in part, by a computing device, such as a mobile phone.

At 110, calendar-related activity is detected within user-accessed content. For example, the user-accessed content can comprise text communication content (e.g., SMS, email, IM, etc.), audio communication content, video communication content, picture content, web page content, third-party application content, and/or other types of user-accessed content.

The calendar-related activity 110 can be detected using a variety of detection techniques, which can be applied individually or in combination. For example, pattern recognition (e.g., pattern matching) techniques, machine learning techniques, audio processing techniques, and/or image processing techniques can be applied. In some implementations, the detection techniques are applied at a computing device (e.g., a mobile phone). For example, a mobile phone can detect calendar-related activity 110 in user-accessed content by applying various detection techniques (e.g., pattern matching, machine learning, audio processing, image processing, and/or other techniques).

In other implementations, the detection techniques are applied at a server environment (e.g., one or more computer servers, cloud computing resources, and/or other computing resources). For example calendar-related activity can be detected 110 in user-accessed content by sending at least a portion of the user-accessed content from a mobile phone to the server environment for processing (e.g., the server environment can apply pattern matching, machine learning, audio processing, image processing, and/or other techniques). The mobile phone can then receive an indication of the calendar-related activity (e.g., date and time for a lunch meeting, location of the lunch meeting, etc.) from the server environment.

In yet other implementations, the detection techniques are applied in a combined approach which uses a computing device (e.g., a mobile phone) and a server environment. For example, calendar-related activity can be detected 110 in user-accessed content by applying one or more detection techniques at the computing device (e.g., at the mobile phone), sending at least a portion of the user-accessed content to a server environment where one or more other detection techniques are applied. The computing device can receive results of the processing from the server environment and use the results in combination with results from local processing at the computing device in detecting the calendar-related activity. In a specific implementation, the computing device uses a pattern recognition technique and the server environment uses a machine learning technique (e.g., comprising natural language processing). Using such a combined approach can be efficient and provide more accurate results. For example, a mobile phone, which typically has limited computing resources, can apply a pattern recognition technique and rely on a server environment, with greater computing power, to perform a more complex machine learning technique. In some implementations, results of the pattern matching technique can be used to decide whether or not additional processing is needed from the server environment (e.g., when reliability or confidence in the pattern matching technique is low). In some implementations, the type of user-accessed content can be used to decide which techniques to apply (e.g., picture content, which may require more complex image processing, can be sent to the server environment for processing).

At 120, calendar information is presented (e.g., in an audio and/or visual format) to the user in response to detecting the calendar-related activity at 110. The calendar information is relevant to the detected calendar-related activity (e.g., relevant to the date and/or time of the detected calendar-related activity). For example, the calendar information can indicate availability of the user (e.g., free-busy information, such as dates and/or times of the calendar items in the user's calendar) in relation to the detected calendar-related activity (e.g., at or near the date and/or time of the detected calendar-related activity). As an example, if the detected calendar-related activity is a proposed lunch meeting at noon on Monday, then the calendar information can comprise calendar items occurring on Monday (e.g., other meetings, appointments, and/or events that are occurring on Monday or that are associated with Monday). The calendar information can be presented in an audio format. For example, the user's computing device can inform the user (e.g., using a synthesized voice) of various time periods when the user is free or busy. The calendar information can also be presented in a visual format. For example, the user's computing device can display the calendar information on the device's screen.

At 130, an indication is received that the user wants to create a calendar item from the calendar-related activity detected at 110. For example, the user can select the calendar information presented at 120 (e.g., tap the displayed calendar information on the user's mobile phone or use a voice command) to indicate that the user wants to create the calendar item.

At 140, the calendar item is saved in the user's calendar (e.g., in the user's local calendar and/or in another calendar associated with the user, such as a remote or cloud-based calendar).

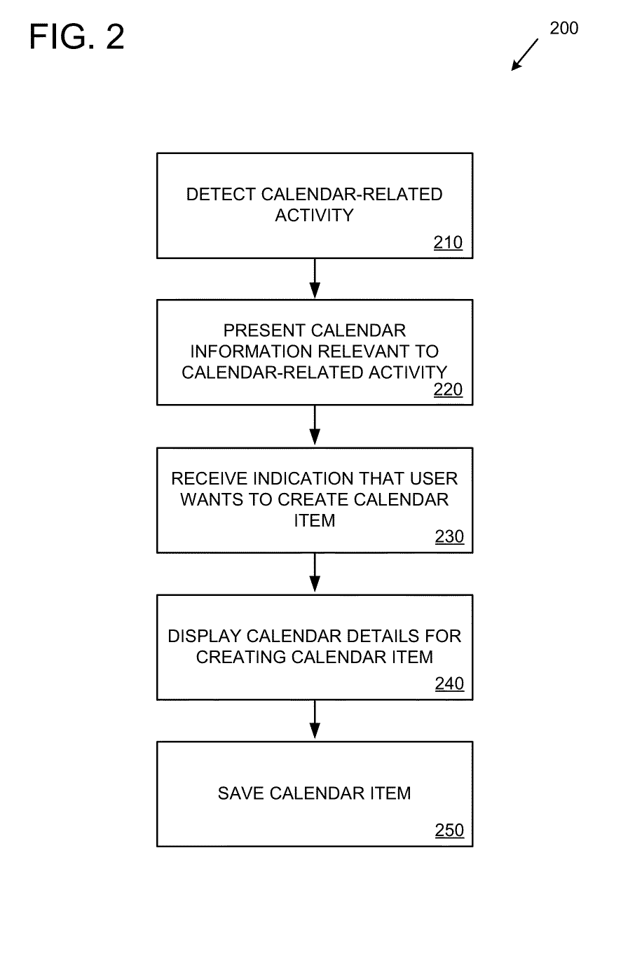

FIG. 2 is a flowchart of another example method 200 for automatically creating calendar items. The example method 200 can be performed, at least in part, by a computing device, such as a mobile phone.

At 210, calendar-related activity is detected within user-accessed content. For example, the user-accessed content can comprise text communication content (e.g., SMS, email, IM, etc.), audio communication content, video communication content, picture content, web page content, third-party application content, and/or other types of user-accessed content. The calendar-related activity can be detected using a variety of detection techniques (e.g., performed by a computing device, by a server environment, or a combination with some techniques performed by the computing device and other techniques performed by the server environment).

At 220, calendar information is presented to the user in response to detecting the calendar-related activity at 210. The calendar information is relevant to the detected calendar-related activity (e.g., relevant to the date and/or time of the detected calendar-related activity). For example, the calendar information can indicate availability of the user, such as free-busy information which can indicate time periods (e.g., days and/or times) when the user is free, time periods when the user is busy, and/or other free-busy information.

At 230, an indication is received that the user wants to create a calendar item from the calendar-related activity detected at 210. For example, the user can select the calendar information presented at 220 (e.g., tap the displayed calendar information on the user's mobile phone or use a voice command) to indicate that the user wants to create the calendar information.

At 240, calendar details are displayed for creating the calendar item in response to receiving the indication at 230. At least some of the calendar details can be populated automatically from the calendar-related activity detected within the user-accessed content. For example, description, date, and/or time details can be automatically populated. The displayed calendar details can also be entered and/or edited by the user. For example, the user can enter a description for the calendar item, enter a type for the calendar item (e.g., an appointment type, a meeting type, an event type, or another type), invite others (e.g., for a meeting calendar item), attach items (e.g., associate pictures or documents with the calendar item), select a specific calendar to save to, etc.

At 250, the calendar item is saved in the user's calendar (e.g., in the user's local calendar and/or in another calendar associated with the user, such as a remote or cloud-based calendar). For example, the calendar details displayed at 240 can include a save button. When the user selects (e.g., taps) the save button, the calendar item can be saved.

In some implementations, an alert is presented to the user to let the user know that calendar-related activity has been detected and the user may want to create a calendar item. The alert can be presented, for example, when the calendar-related activity is detected (e.g., at 110 or 210) and/or when the calendar information is displayed (e.g., at 120 or 220). The alert can be presented, for example, using a visual indication (e.g., an icon, color, and/or other visual indication), using an audio indication (e.g., a beep or tone), and/or using a haptic indication (e.g., a vibration).

In some implementations, the calendar-related activity is detected within an application related to the user-accessed content. For example, the calendar-related activity can be detected within an SMS application running on the user's mobile phone while the user is texting with a friend. As another example, the calendar-related activity can be detected within a photo application running on the user's mobile phone while the user takes a picture (with the mobile phone's camera) of a concert poster. As yet another example, the calendar-related activity can be detected within a web browser application running on the user's mobile phone while the user browses a movie listing on a movie theater web page. Regardless of the application within which the calendar-related activity is detected, the calendar information can be displayed without the user having to leave the application. For example, if the user is using an SMS application, the calendar information can be displayed without the user having to leave the SMS application or switch to another application (e.g., the calendar information can be displayed as a pop-up). Similarly, the user can indicate a desire to create a calendar item, and the calendar item can be saved, without the user having to leave the current application (e.g., by clicking on the calendar information pop-up that is displayed while the user is using the SMS application). For example, with reference to FIG. 1, detecting the calendar-related activity at 110 can be performed within the application (e.g., SMS application, email application, photo application, web browser application, voice mail application, phone application, or another application), and displaying calendar information at 120, receiving the indication that the user wants to create the calendar item at 130, and saving the calendar item at 140 can be performed without leaving the application (e.g., without the user having to switch to a different application to view calendar information, such as free-busy information, enter calendar details, and save the calendar item). As another example, with reference to FIG. 2, detecting the calendar-related activity at 210 can be performed within the application (e.g., SMS application, email application, photo application, web browser application, voice mail application, phone application, or another application), and displaying calendar information at 220, receiving the indication at 230 that the user wants to create the calendar item, displaying calendar details at 240, and saving the calendar item at 250 can be performed without leaving the application (e.g., without the user having to switch to a different application to view calendar information, such as free-busy information, enter calendar details, and save the calendar item)

### Example 6

### Example Implementation

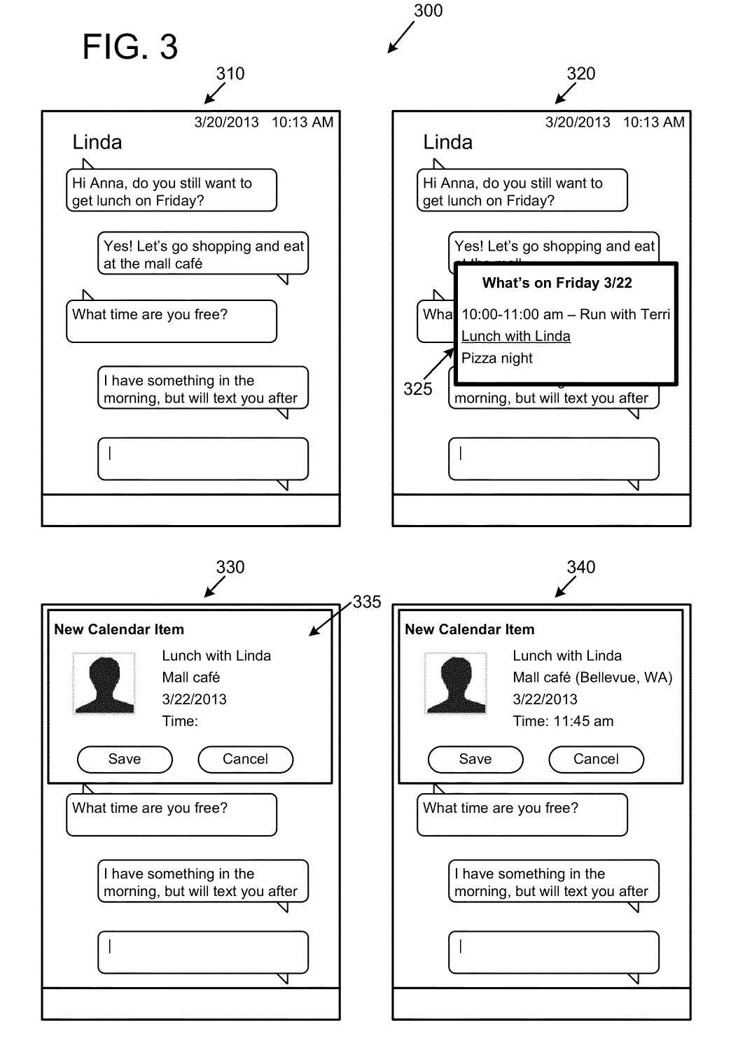

FIG. 3 depicts an example implementation for automatically creating calendar items within an SMS application running on a mobile phone. Specifically, FIG. 3 depicts example screenshots of a mobile phone display at four stages during the process of creating the calendar item while using the SMS application.

As depicted in the first example screenshot 310, the user of the mobile phone is using an SMS application. The user is texting with Linda, who is asking the user (Anna in this example) if the user wants to get lunch on Friday. The user responds by stating, “Yes! Let's go shopping and eat at the mall.”

From the user-accessed content (the text content of the SMS exchange in this example), calendar-related activity is detected. For example, the calendar-related activity can be detected based on a variety of techniques, such as pattern recognition (e.g., based on the words “lunch” and a day “Friday” in the text content). Other techniques can be applied as well, such as natural language processing.

As depicted in the second example screenshot 320, calendar information is displayed at 325. The calendar information depicted at 325 comprises free-busy information for Friday, March 22^{nd}. The free-busy information includes a calendar item for a 10:00-11:00 am “Run with Terri” and a calendar item for a “Pizza night” event (e.g., an event that occurs on Friday but is not associated with a specific time period). The calendar information is relevant to the calendar-related activity because it occurs on the day (Friday, 3/22) that the user is considering for the lunch appointment with Linda. Using the displayed calendar information at 325, the user can quickly and efficiently tell what is going on that day (e.g., what is currently in the user's calendar on Friday, 3/22), which helps the user decide whether to create the calendar item, propose a different day and/or time, or make some other decision regarding the lunch appointment. Additional calendar information from Linda's calendar could also be displayed in the second example screenshot 320 (e.g., similar to how the user's calendar information is displayed at 325).

Instead of, or in addition to, presenting the calendar information in a visual format (as depicted at 325), the calendar information can be presented in an audio format (e.g., the mobile phone can speak the calendar information using a synthesized voice). For example, instead of an SMS communication, the communication can be a voice call and the calendar information can be presented by the mobile phone in an audio format during or after the phone call between the user and Linda (e.g., telling the user what calendar items are already scheduled for Friday, when the user is free on Friday, proposed alternative dates and/or times, etc.).

Also depicted in the calendar information at 325 is an indication of a proposed calendar item for the lunch appointment with Linda. The user can select the calendar information (e.g., select the proposed “Lunch with Linda” link) to indicate that the user wants to create a calendar item for the lunch appointment. The user can use a different method to indicate that the user wants to create a calendar item (e.g., selecting a different user interface element, such as a button or icon, speaking a voice command, etc.).

As depicted in the third example screenshot 330, the user has indicated that the user wants to create the calendar item. In response, a user interface area is displayed at 335 for creating the calendar item. In the user interface area displayed at 335, calendar details have been automatically filled in (e.g., populated) based on the calendar-related activity. Specifically, a description of the calendar item has been entered (“Lunch with Linda”), the location has been entered (“Mall café”), the date has been entered (Mar. 22, 2013), and a photo of Linda has been associated with the calendar item (e.g., obtained from the user's contact information for Linda). Other details can also be filled in, such as a proposed time for the lunch (e.g., “12:00-1:00 pm”).

The user can modify the calendar items as needed. For example, the user could change the location or date for the lunch appointment. As depicted in the third example screenshot 340, the user has modified the location (“Bellevue, Wash.”) and entered the time for the lunch appointment (“11:45 am”).

Once the user is satisfied with the calendar item, the user can save the calendar item to the user's calendar (e.g., using the save button, as depicted in the example screenshot 340). The user can also edit the saved calendar item at a later time (e.g., to add or modify details).

In some implementations, calendar details (e.g., as depicted at 335) can be provided based on the calendar item type. For example, if the calendar item is for a meeting, then details can be provided for inviting other participants (e.g., names and email addresses). Details can also be provided for indicating the user's time during the calendar item, such as free, busy, unavailable, out of office, etc.

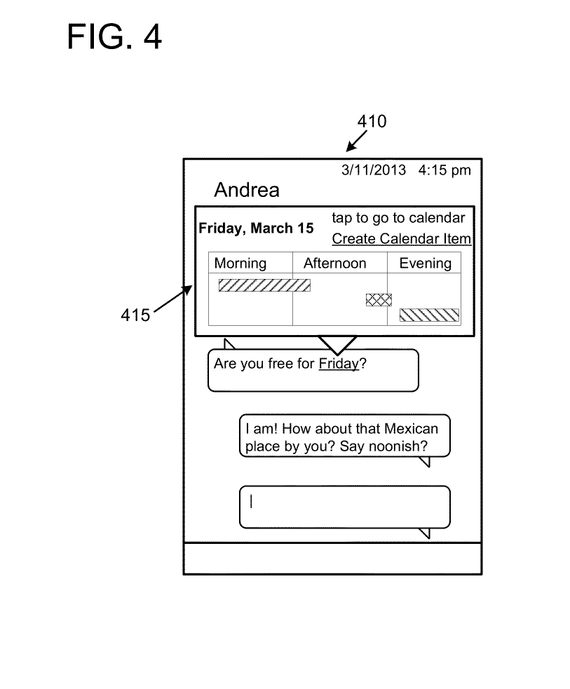

FIG. 4 depicts an example screenshot 410 for automatically creating calendar items, including displaying graphical free-busy information. As depicted in the example screenshot 410, the user is communicating via SMS with Andrea. The user and Andrea are discussing the possibility of lunch on Friday. In response to detecting this calendar-related activity, free-busy information is automatically displayed at 415. In this example screenshot 410, the free-busy information is displayed in a graphical format (e.g., which can be a variation of the text-based free-busy information displayed in the example screenshot 320 at 325), which depicts three calendar items that are currently scheduled for Friday, March 15^{th}, one in the morning to early afternoon, one in late afternoon, and one in the evening. Other information could also be displayed at 415 (e.g., if the user selects one of the calendar items, additional calendar information can be displayed such as a description of the item and the exact time period for which the item is scheduled). Using the displayed free-busy calendar information at 415, the user can quickly and efficiently decide whether to schedule the lunch appointment on Friday, propose another day or time, or take some other action.

From the example screenshot 410, the user can create a calendar item for the lunch appointment on Friday. For example, the user can select (e.g., tap on) the free-busy information at 415 (e.g., select the “Create Calendar Item” link) to indicate that the user wants to create the calendar item. Upon receiving the indication that the user wants to create the calendar item, calendar details can be displayed (e.g., similar to the calendar details area displayed at 335).

From the displayed free-busy information at 415, the user also has the option to view the user's entire calendar (e.g., by selecting the “tap to go to calendar” text). Viewing the user's calendar can involve displaying another pop-up user interface area, which can be displayed without the user leaving the current SMS application. Alternatively, viewing the user's calendar can involve switching to a calendar application.

### Example 7

### Environment for Automatically Creating Calendar Items

In any of the examples herein, an environment can support automatic creation of calendar items. For example, mobile computing devices (e.g., mobile phones, tablets, and other types of mobile computing devices) can detect calendar-related activity in a variety of user-accessed content. The mobile computing devices can detect the calendar-related activity locally or in combination with a server environment. For example, one or more detection techniques can be applied to the user-accessed content locally while one or more detection techniques (e.g., one or more detection techniques different from the techniques applied locally) can be applied by a server environment.

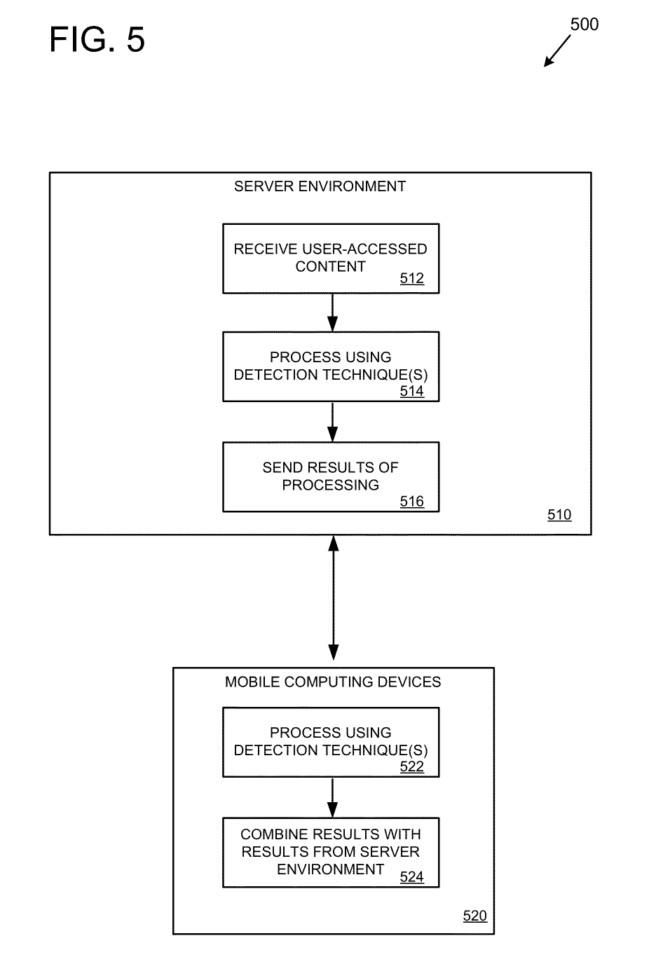

FIG. 5 is a diagram of an example environment 500 supporting automatic creation of calendar items by mobile computing devices. The example environment 500 includes a server environment 510 (e.g., comprising computer servers, databases resources, networking resources, cloud computing resources, etc.) and one or more mobile computing devices 520 (e.g., mobile phones).

The mobile computing devices 520 are configured to perform operations for automatically creating calendar items. For example, the mobile computing devices 520 can detect calendar-related activity in user-accessed content, display calendar information relevant to the calendar-related activity, receive indications that users want to create calendar items, display calendar details for creating the calendar items, and save the calendar items.

In order to detect calendar-related activity in user-accessed content (e.g., SMS messages, emails, pictures, web pages, third-party applications, and other types of user-accessed content), the mobile computing devices 520 can use a variety of detection techniques locally (e.g., pattern recognition techniques, machine learning techniques, audio processing techniques, image processing techniques, and/or other techniques). A variety of detection techniques can also be used by the server environment 510 (e.g., the mobile computing devices 520 can send the user-accessed content to the server environment 510 for processing, or a combined approach can be used that includes processing performed by both the server environment 510 and the mobile computing devices 520).

In some implementations, a combined approach is used for detecting the calendar-related activity. In the combined approach, the server environment 510 receives at least a portion of the user-accessed content at 512 from the mobile computing devices 520 (e.g., text content from an series of SMS messages, a picture or a portion of a picture, one or more email messages or portions of email messages, a link to a web page, etc.). The server environment 510 processes the received user-accessed content using one or more detection techniques at 514. The server environment sends results of the processing back to the mobile computing devices 520 at 516. For example, the results of the processing can comprise calendar details detected within the user-accessed content (e.g., calendar item descriptions, locations, dates and/or times, participants, calendar item types (e.g., appointments, meetings, events), etc.).

In the combined approach, the mobile computing devices 520 also process at least a portion of the user-accessed content using one or more detection techniques at 522. The mobile computing devices 520 receive the results from the processing performed at the server environment 510 and use them in combination with results from the local processing at 524. For example, certain details can be detected locally (e.g., dates and/or times) while other details can be detected by the server environment 510 (e.g., descriptions, locations, and calendar item types). In some implementations, the detection techniques used by the mobile computing devices 520 at 522 are different form the detection techniques used by the server environment 510 at 514. For example, the mobile computing devices 520 can use a pattern recognition detection technique and the server environment 510 can use a machine learning detection technique.

### Example 8

### Computing Systems

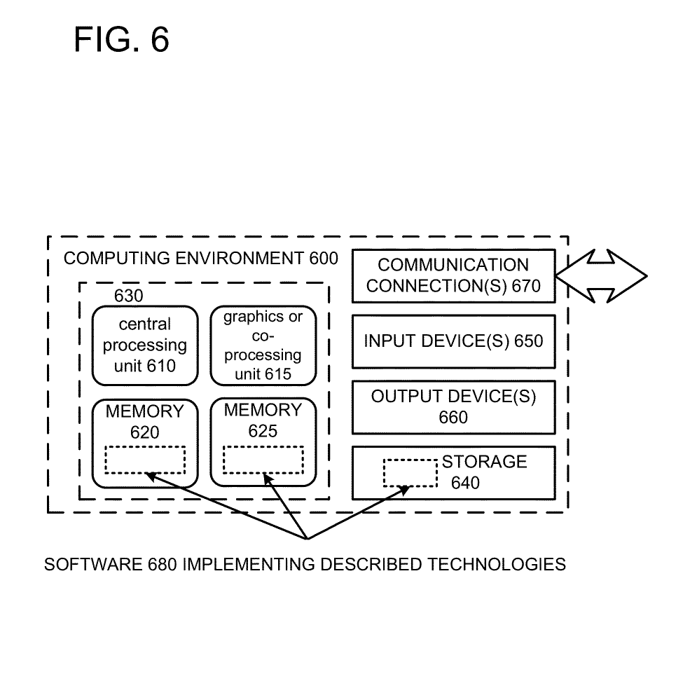

FIG. 6 depicts a generalized example of a suitable computing system 600 in which the described innovations may be implemented. The computing system 600 is not intended to suggest any limitation as to scope of use or functionality, as the innovations may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more innovations described herein, in the form of computer-executable instructions suitable for execution by the processing unit(s).

A computing system may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information and which can be accessed within the computing system 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing system 600. For video encoding, the input device(s) 650 may be a camera, video card, TV tuner card, or similar device that accepts video input in analog or digital form, or a CD-ROM or CD-RW that reads video samples into the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 9

### Mobile Device

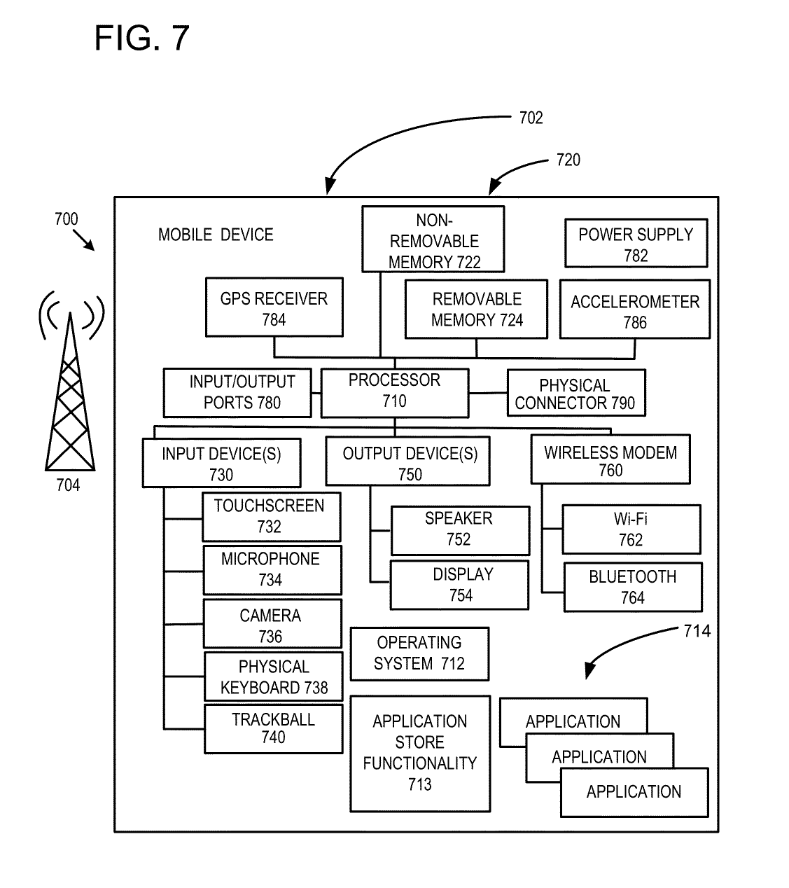

FIG. 7 is a system diagram depicting an exemplary mobile device 700 including a variety of optional hardware and software components, shown generally at 702. Any components 702 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 704, such as a cellular, satellite, or other network.

The illustrated mobile device 700 can include a controller or processor 710 (e.g., signal processor, microprocessor, ASIC, or other control and processing logic circuitry) for performing such tasks as signal coding, data processing, input/output processing, power control, and/or other functions. An operating system 712 can control the allocation and usage of the components 702 and support for one or more application programs 714. The application programs can include common mobile computing applications (e.g., email applications, calendars, contact managers, web browsers, messaging applications), or any other computing application. Functionality 713 for accessing an application store can also be used for acquiring and updating application programs 714.

The illustrated mobile device 700 can include memory 720. Memory 720 can include non-removable memory 722 and/or removable memory 724. The non-removable memory 722 can include RAM, ROM, flash memory, a hard disk, or other well-known memory storage technologies. The removable memory 724 can include flash memory or a Subscriber Identity Module (SIM) card, which is well known in GSM communication systems, or other well-known memory storage technologies, such as “smart cards.” The memory 720 can be used for storing data and/or code for running the operating system 712 and the applications 714. Example data can include web pages, text, images, sound files, video data, or other data sets to be sent to and/or received from one or more network servers or other devices via one or more wired or wireless networks. The memory 720 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 700 can support one or more input devices 730, such as a touchscreen 732, microphone 734, camera 736, physical keyboard 738 and/or trackball 740 and one or more output devices 750, such as a speaker 752 and a display 754. Other possible output devices (not shown) can include piezoelectric or other haptic output devices. Some devices can serve more than one input/output function. For example, touchscreen 732 and display 754 can be combined in a single input/output device.

The input devices 730 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 712 or applications 714 can comprise speech-recognition software as part of a voice user interface that allows a user to operate the device 700 via voice commands. Further, the device 700 can comprise input devices and software that allows for user interaction via a user's spatial gestures, such as detecting and interpreting gestures to provide input to a gaming application.

A wireless modem 760 can be coupled to an antenna (not shown) and can support two-way communications between the processor 710 and external devices, as is well understood in the art. The modem 760 is shown generically and can include a cellular modem for communicating with the mobile communication network 704 and/or other radio-based modems (e.g., Bluetooth 764 or Wi-Fi 762). The wireless modem 760 is typically configured for communication with one or more cellular networks, such as a GSM network for data and voice communications within a single cellular network, between cellular networks, or between the mobile device and a public switched telephone network (PSTN).

The mobile device can further include at least one input/output port 780, a power supply 782, a satellite navigation system receiver 784, such as a Global Positioning System (GPS) receiver, an accelerometer 786, and/or a physical connector 790, which can be a USB port, IEEE 1394 (FireWire) port, and/or RS-232 port. The illustrated components 702 are not required or all-inclusive, as any components can be deleted and other components can be added.

### Example 10

### Cloud-Supported Environment

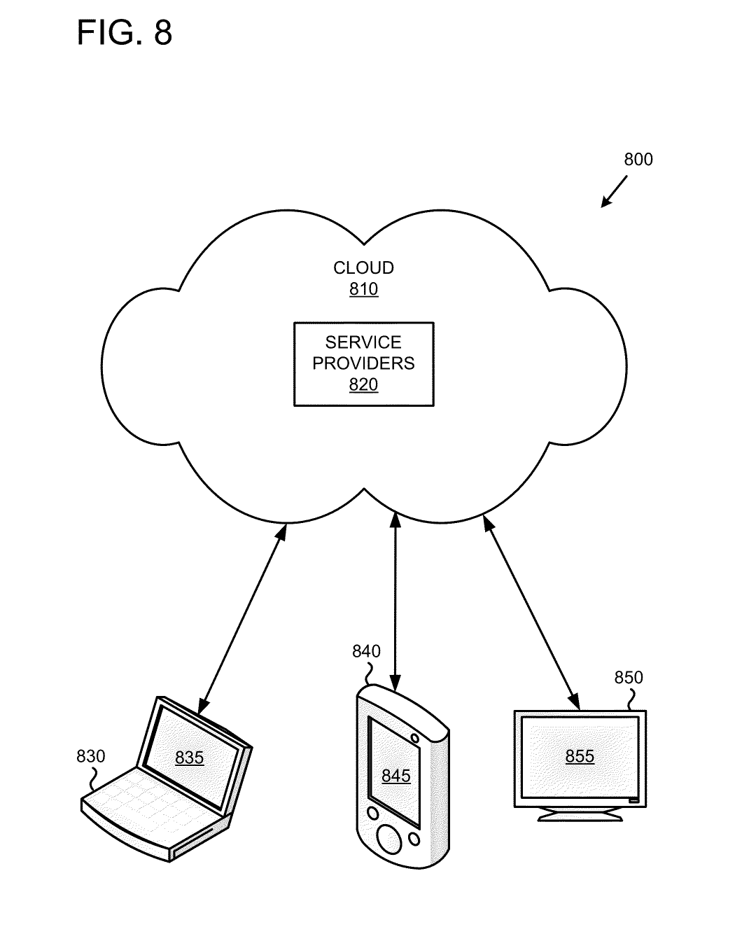

FIG. 8 illustrates a generalized example of a suitable implementation environment 800 in which described embodiments, techniques, and technologies may be implemented. In the example environment 800, various types of services (e.g., computing services) are provided by a cloud 810. For example, the cloud 810 can comprise a collection of computing devices, which may be located centrally or distributed, that provide cloud-based services to various types of users and devices connected via a network such as the Internet. The implementation environment 800 can be used in different ways to accomplish computing tasks. For example, some tasks (e.g., processing user input and presenting a user interface) can be performed on local computing devices (e.g., connected devices 830, 840, 850) while other tasks (e.g., storage of data to be used in subsequent processing) can be performed in the cloud 810.

In example environment 800, the cloud 810 provides services for connected devices 830, 840, 850 with a variety of screen capabilities. Connected device 830 represents a device with a computer screen 835 (e.g., a mid-size screen). For example, connected device 830 could be a personal computer such as desktop computer, laptop, notebook, netbook, or the like. Connected device 840 represents a device with a mobile device screen 845 (e.g., a small size screen). For example, connected device 840 could be a mobile phone, smart phone, personal digital assistant, tablet computer, and the like. Connected device 850 represents a device with a large screen 855. For example, connected device 850 could be a television screen (e.g., a smart television) or another device connected to a television (e.g., a set-top box or gaming console) or the like. One or more of the connected devices 830, 840, 850 can include touch screen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 800. For example, the cloud 810 can provide services for one or more computers (e.g., server computers) without displays.

Services can be provided by the cloud 810 through service providers 820, or through other providers of online services (not depicted). For example, cloud services can be customized to the screen size, display capability, and/or touch screen capability of a particular connected device (e.g., connected devices 830, 840, 850).

In example environment 800, the cloud 810 provides the technologies and solutions described herein to the various connected devices 830, 840, 850 using, at least in part, the service providers 820. For example, the service providers 820 can provide a centralized solution for various cloud-based services. The service providers 820 can manage service subscriptions for users and/or devices (e.g., for the connected devices 830, 840, 850 and/or their respective users).

### Example 11

### Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 6, computer-readable storage media include memory 620 and 625, and storage 640. By way of example and with reference to FIG. 7, computer-readable storage media include memory and storage 720, 722, and 724. The term computer-readable storage media does not include communication connections (e.g., 670, 760, 762, and 764) such as signals and carrier waves.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method, implemented at least in part by a computing device, for automatically creating calendar items, the method comprising:
detecting, at least in part by the computing device, calendar-related activity, wherein the calendar-related activity is detected within user-accessed content;
in response to detecting the calendar-related activity, presenting, by the computing device to a user of the computing device, calendar information, wherein the calendar information is relevant to the calendar-related activity, and wherein the calendar information comprises availability information related to the user's calendar;
receiving, by the computing device, an indication that the user wants to create a calendar item based, at least in part, on the detected calendar-related activity; and
saving, by the computing device, the calendar item in the user's calendar;
wherein the method is configured to detect calendar-related activity within user-accessed content comprising:
text user-accessed content;
picture user-accessed content;
third-party application user-accessed content; and
web page user-accessed content.

2. The method of claim 1 wherein the method is configured to receive indications to create appointment calendar items, meeting calendar items, and event calendar items.

3. The method of claim 1 wherein presenting the calendar information comprises:
presenting free-busy information obtained from the user's calendar, wherein the free-busy information is based on a time period indicated by the detected calendar-related activity.

4. The method of claim 1 wherein presenting the calendar information comprises presenting at least one of:
an indication of a time period when the user is free based at least in part upon the user's calendar; and
an indication of a time period when the user is busy based at least in part upon the user's calendar.

5. The method of claim 1 further comprising:
in response to detecting the calendar-related activity, presenting an alert, by the computing device to the user, wherein the alert is associated with the presenting the calendar information, and wherein the alert comprises at least one of an audio alert, a visual alert, and a haptic alert.

6. The method of claim 1 further comprising:
in response to receiving the indication that the user wants to create a calendar item, displaying, to the user, calendar details for creating the calendar item, wherein at least some of the calendar details are populated automatically from the calendar-related activity detected with the user-accessed content.

7. The method of claim 1 wherein the detecting the calendar-related activity is performed within an application running on the computing device, and wherein the presenting, the receiving, and the saving are performed without leaving the application.

8. The method of claim 1 wherein the detecting calendar-related activity comprises:
sending at least a portion of the user-accessed content to a server environment for processing; and
receiving, from the server environment, an indication of the calendar-related activity.

9. The method of claim 1 wherein the detecting calendar-related activity comprises:
processing, by the computing device, the user-accessed content using a first detection technique; and
sending at least a portion of the user-accessed content to a server environment for processing using a second detection technique;
wherein the detecting calendar-related activity uses results of the processing using the first detection technique and results of the processing using the second detection technique.

10. The method of claim 1 further comprising:
in response to detecting the calendar-related activity, presenting, by the computing device to the user of the computing device, additional calendar information, wherein the additional calendar information is relevant to the calendar-related activity, and wherein the additional calendar information comprises availability information related to another user's calendar.

11. A computing device comprising:
a processing unit;
memory; and
a display;
the computing device configured to perform operations for automatically creating calendar items, the operations comprising:
detecting calendar-related activity, wherein the calendar-related activity is detected within user-accessed content;
in response to detecting the calendar-related activity, presenting, to a user of the computing device, calendar information, wherein the calendar information is relevant to the calendar-related activity, and wherein the calendar information comprises availability information related to the user's calendar;
receiving an indication that the user wants to create a calendar item based, at least in part, on the detected calendar-related activity; and
saving the calendar item in the user's calendar;
wherein the computing device is configured to detect calendar-related activity within user-accessed content comprising:
text user-accessed content;
picture user-accessed content;
third-party application user-accessed content; and
web page user-accessed content.

12. The computing device of claim 11 wherein the operations are configured to receive indications to create appointment calendar items, meeting calendar items, and event calendar items.

13. The computing device of claim 11 wherein presenting the calendar information comprises:
presenting free-busy information obtained from the user's calendar, wherein the free-busy information is based on a time period indicated by the detected calendar-related activity.

14. The computing device of claim 11 the operations further comprising:
in response to detecting the calendar-related activity, presenting an alert, to the user, wherein the alert is associated with the presenting the calendar information, and wherein the alert comprises at least one of an audio alert, a visual alert, and a haptic alert.

15. The computing device of claim 11 the operations further comprising:
in response to receiving the indication that the user wants to create a calendar item, displaying, to the user, calendar details for creating the calendar item, wherein at least some of the calendar details are populated automatically from the calendar-related activity detected with the user-accessed content.

16. The computing device of claim 11 the operations further comprising:
in response to detecting the calendar-related activity, presenting, to the user, additional calendar information, wherein the additional calendar information is relevant to the calendar-related activity, and wherein the additional calendar information comprises availability information related to another user's calendar.

17. A computer-readable storage medium storing computer-executable instructions for causing a computing device to perform a method for automatically creating calendar items, the method comprising:
detecting calendar-related activity, wherein the calendar-related activity is detected within user-accessed content;
in response to detecting the calendar-related activity, displaying, to a user of the computing device, calendar information, wherein the calendar information is relevant to the calendar-related activity, and wherein the calendar information comprises free-busy information obtained from the user's calendar, wherein the free-busy information is based on a time period indicated by the detected calendar-related activity;
receiving an indication that the user wants to create a calendar item based, at least in part, on the detected calendar-related activity;
in response to receiving the indication that the user wants to create a calendar item, displaying, to the user, calendar details for creating the calendar item, wherein at least some of the calendar details are populated automatically from the calendar-related activity detected with the user-accessed content; and
saving the calendar item in the user's calendar;
wherein the method is configured to receive indications to create appointment calendar items, meeting calendar items, and event calendar items; and
wherein the method is configured to detect calendar-related activity within user-accessed content comprising:
text user-accessed content;
digital ink user-accessed content;
picture user-accessed content;
third-party application user-accessed content; and
web page user-accessed content.

18. The computer-readable storage medium of claim 17 wherein the detecting calendar-related activity comprises:
sending at least a portion of the user-accessed content to a server environment for processing; and
receiving, from the server environment, an indication of the calendar-related activity.

19. The computer-readable storage medium of claim 17 the method further comprising:
in response to detecting the calendar-related activity, presenting an alert, to the user, wherein the alert is associated with the presenting the calendar information, and wherein the alert comprises at least one of an audio alert, a visual alert, and a haptic alert.

20. The computer-readable storage medium of claim 17 the method further comprising:
in response to detecting the calendar-related activity, displaying, to the user of the computing device, additional calendar information, wherein the additional calendar information is relevant to the calendar-related activity, and wherein the additional calendar information comprises availability information related to another user's calendar.
